(19) United States
(12) Patent Application Publication
(10) Pub. No.: US 2009/0025486 A1
(43) Pub. Date: Jan. 29, 2009

(54) Static fluid meter

(76) Inventors: Alain Cros, Creches Sur Saone (FR); Alcide Mercier, Macon (FR)

Correspondence Address: SOFER & HAROUN LLP., 317 MADISON AVENUE, SUITE 910, NEW YORK, NY, 10017, US

(21) Appl. No.: 12/217,760

(22) Filed: Jul. 8, 2008

(30) Foreign Application Priority Data
Jul. 27, 2007 (EP) 07 301 284.1

(51) Int. Cl. G01F 1/58

(52) U.S. Cl. 73/861.12

(57) ABSTRACT

A static fluid meter includes a flow rate sensor having a set of stationary measuring parts, and a measurement tube having one opening that serves as a fluid inlet and another opening as a fluid outlet, the tube containing internally a first set of said measuring parts and supporting externally a second set of said measuring parts. An outer case into which said measurement tube is inserted and fastened in leaktight manner, contains at least parts for processing data from said sensor. The case is made from a box provided with two through orifices in its sides for passing the measurement tube assembly and for leaktight fastening to corresponding flanges arranged on said measurement tube.

### RELATED APPLICATION

This application claims the benefit of priority from EP 07 301 284.1, filed on Jul. 27, 2007, the entirety of which is incorporated herein by reference.

### FIELD OF THE INVENTION

The invention relates to a static fluid meter, in particular a water meter.

### BACKGROUND OF THE INVENTION

By way of example it relates to a fluid meter having a magnetic sensor comprising two electrodes that are subjected to an alternating magnetic field, the electrodes comprising a metal together with an ionic compound of said metal interposed between the metal and the fluid, as described in patent document WO 2004/090475.

Although that prior document describes the general arrangement of such a sensor, it does not give any indication about the structure of a fluid meter fitted with such a sensor.

Patent document GB 2 333 366 describes an electromagnetic fluid meter including a fluid sensor comprising a set of stationary measuring parts, including a measurement tube having one opening that serves as a fluid inlet and another opening that serves as a fluid outlet, and containing internally a first set of said measuring parts, i.e. electrodes, and supporting externally a second set of measuring parts, i.e. a coil, together with an outer case in which said measurement tube is inserted and fastened in leaktight manner, the case containing at least parts for processing data.

Such a meter is relatively complex to assemble.

### OBJECT AND SUMMARY OF THE INVENTION

The object of the invention is to propose a static fluid meter that is particularly simple and ergonomic to assemble.

The term “static meter” is used to mean a meter that does not have any moving parts for measuring flow rate. This covers meters having magnetic sensors, ultrasound meters, and fluidic meters that are also known as vibrating jet meters.

The invention thus provides a static fluid meter including a flow rate sensor comprising a set of stationary measuring parts, and
a measurement tube having one opening that serves as a fluid inlet and another opening as a fluid outlet, the tube containing internally a first set of said measuring parts and supporting externally a second set of said measuring parts; and
an outer case into which said measurement tube is inserted and fastened in leaktight manner, and containing at least parts for processing data from said sensor;

wherein said case is constituted by a box provided with two through orifices in its sides for passing the measurement tube assembly and for leaktight fastening to corresponding flanges arranged on said measurement tube.

By virtue of being separated in this way into two assembly modules, namely a measurement tube and a case, the various measuring parts can easily be mounted in and on the measurement tube, with access to the location for mounting these parts then being easy.

The measuring parts can then easily be connected to the data processing parts once the measurement tube has been put into place in the case.

It is thus possible for all of the parts of the meter to be assembled in simple and safe manner, step by step.

In addition, the materials selected for making these two modules can be optimized in terms of their properties and costs. For example, the measurement tube that needs to withstand fluid pressures can be made of a strong plastics material, e.g. of “Grivory”, having thickness and general design to match. The outer case is not subjected to any particular force and can therefore be made of an ordinary plastics material, e.g. acrylonitrile butadiene styrene copolymer (ABS), or polycarbonate (PC), or ABS/PC. These two modules may also be different in appearance, e.g. they may have different colors.

In a preferred embodiment, said outer case contains a display unit.

Preferably, said measurement tube includes, on its wall, at least one stud, having engaged and fastened thereon a part of said second set.

Preferably, said measurement tube includes in its wall at least one orifice having a said part of the first set engaged and fastened therein.

Preferably, said measurement tube includes, on its wall, at least one stud, having engaged and fastened thereon a said part of the second set.

Advantageously, a protective cap is placed around said second set of parts.

Said case can be provided with a cover that may be transparent in order to read the meter.

The invention relates more particularly to a static fluid meter comprising a magnetic flow rate sensor as specified above, and wherein said first set of said measuring parts is made up of two electrodes.

Preferably, said second set of said measuring parts is made up of two electromagnetic coils.

Said parts for processing data may comprise a printed circuit board and a battery.

Preferably, said measurement tube and said case are made of plastics material.

The invention is described below in detail with the help of figures that merely show a preferred embodiment of the invention.

### BRIEF DESCRIPTION OF THE DRAWINGS

The figures show the method of assembling a meter of the invention, step by step.

FIGS. 1A, 2 to 4, 5A, 6, 7A, and 8 to 13 are perspective views.

FIGS. 1B, 5B, and 7B are longitudinal section views corresponding to FIGS. 1A, 5A, and 7A, respectively.

The static fluid meter in accordance with the invention is a magnetic sensor meter of the type described in patent document WO 2004/090475.

### MORE DETAILED DESCRIPTION

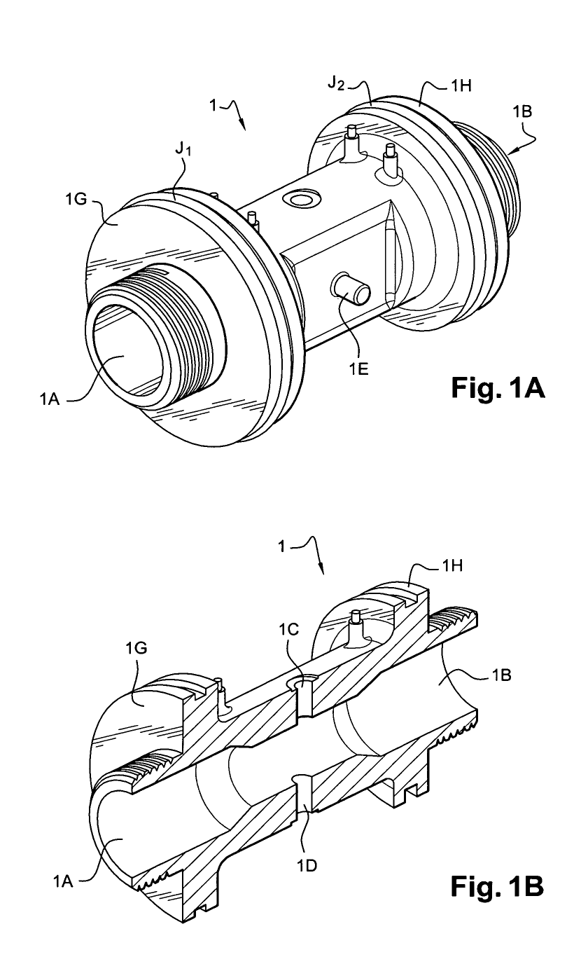

It comprises firstly a measurement tube 1, advantageously made of plastics material, and shown in FIGS. 1A and 1B. The measurement tube includes an opening 1A serving as a fluid inlet and provided with a thread for connection to an inlet pipe, and another opening 1B serving as a fluid outlet and provided with a connection thread for connection to an outlet pipe.

The measurement tube is designed to contain internally a first set of measurement parts, constituted in this example by two electrodes, and to support on the outside a second set of measurement parts, in this example two electromagnetic coils. For this purpose, it includes in its wall at least one orifice 1C, 1D into which there is engaged and secured a part of the first set, and on its wall at least one stud 1E, 1F, having fastened thereon by mutual engagement a part of the second set. The measurement tube 1 also has two annular flanges 1G, 1H, each provided with a groove for receiving a sealing gasket J1, J2.

In the embodiment described herein, the measurement tube has two orifices 1C, 1D that are diametrically opposite, and two studs 1E, 1F that are diametrically opposite.

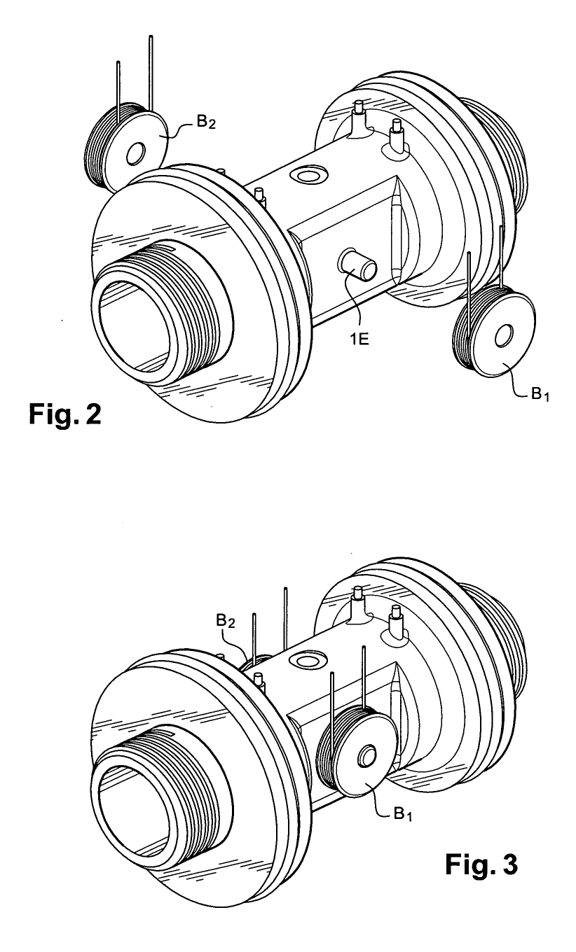

As shown in FIGS. 2 and 3, in a first assembly step, a respective electromagnetic coil B1, B2 is engaged and fastened on each of the studs 1E, 1F.

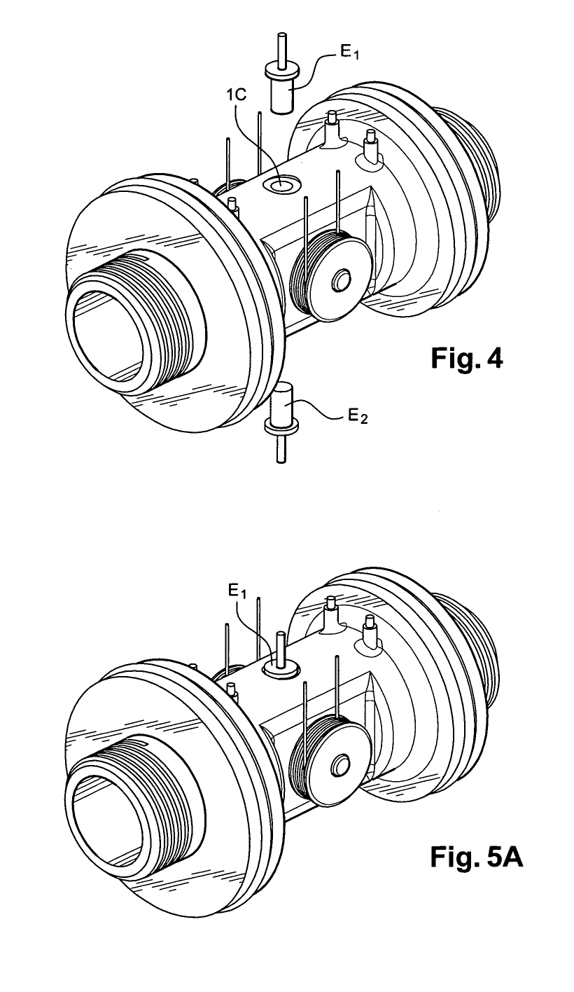

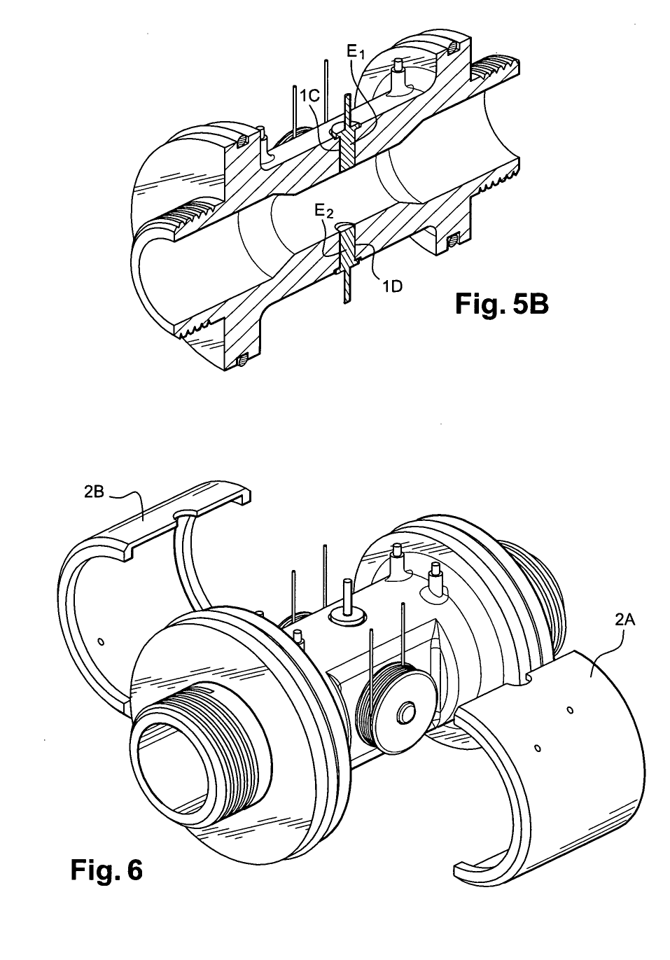

As shown in FIGS. 4, 5A, and 5B, in a subsequent or simultaneous assembly step, a respective electrode E1, E2 is engaged and fastened in each of the orifices 1C, 1D. To do this, each electrode E1, E2 is inserted into the corresponding orifice 1C, 1D so as to come into contact with the fluid, a shoulder bearing against the bottom of a counterbore in each orifice 1C, 1D, and the electrode including a connection pin situated on the outside of the measurement tube 1.

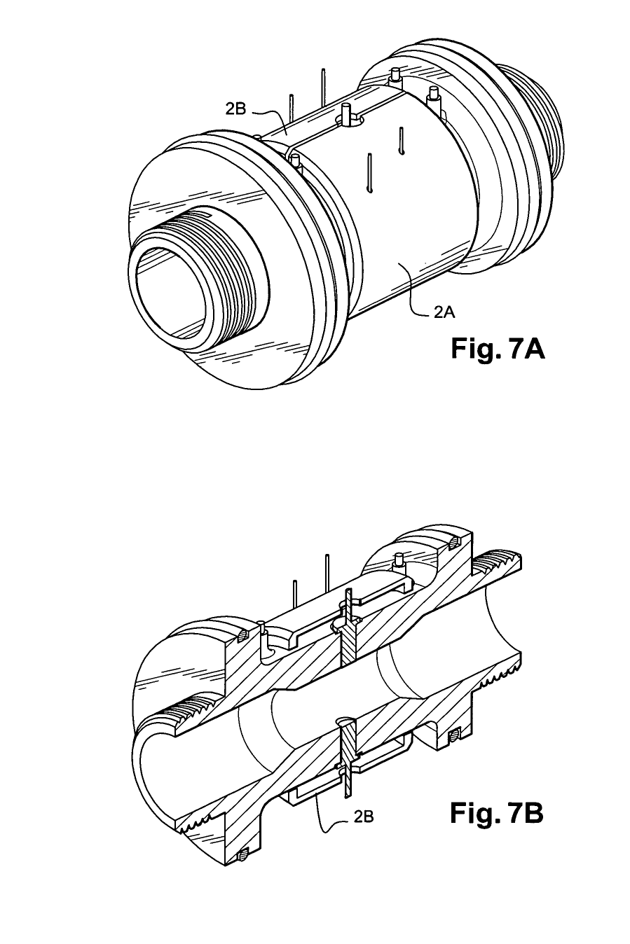

As shown in FIGS. 6 and 7, in a following assembly step, a shielding cap is placed around the coils B1, B2. The cap is made up of two half-parts 2A, 2B forming a cylindrical sleeve provided with through orifices for the connection pins of the electrodes E1 and E2, and of the coils B1, B2.

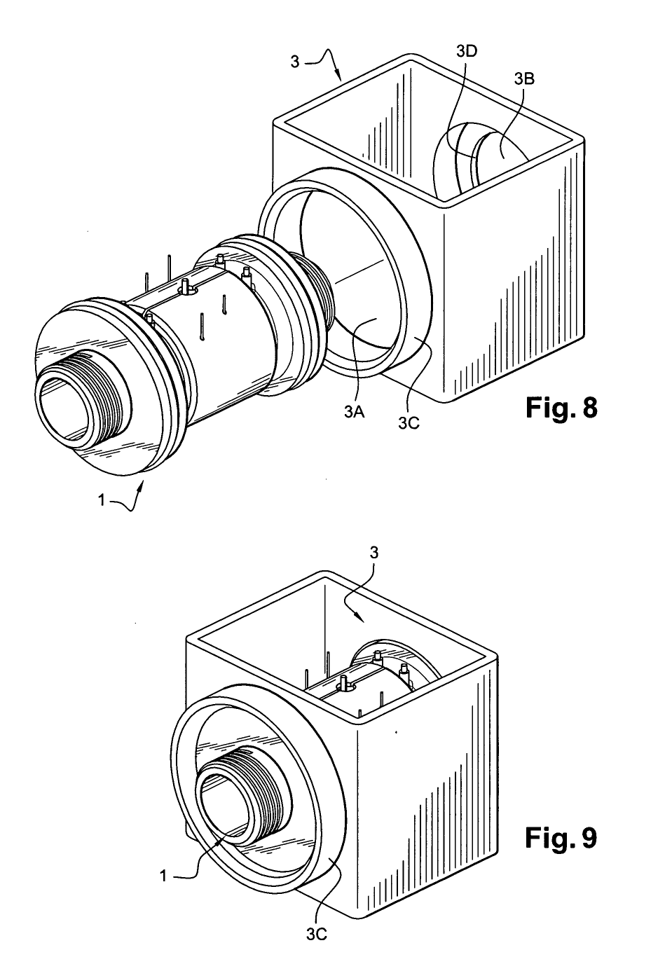

As shown in FIGS. 8 and 9, in a following assembly step, the measurement tube 1 as equipped in this way is inserted in an outer case 3, advantageously made of plastics material, in which it is fastened in leaktight manner for the purpose of containing at least certain components for processing data from the sensor, and also a display unit. The case 3 is constituted by a box provided with two through orifices 3A, 3B in its sides for passing the measurement tube and for fastening in leaktight manner to the annular flanges 1H, 1G each fitted with its respective gasket J1, J2 that comes tightly into contact against two longitudinally-extending collars 3C, 3D arranged around the through orifices 3A and 3B respectively.

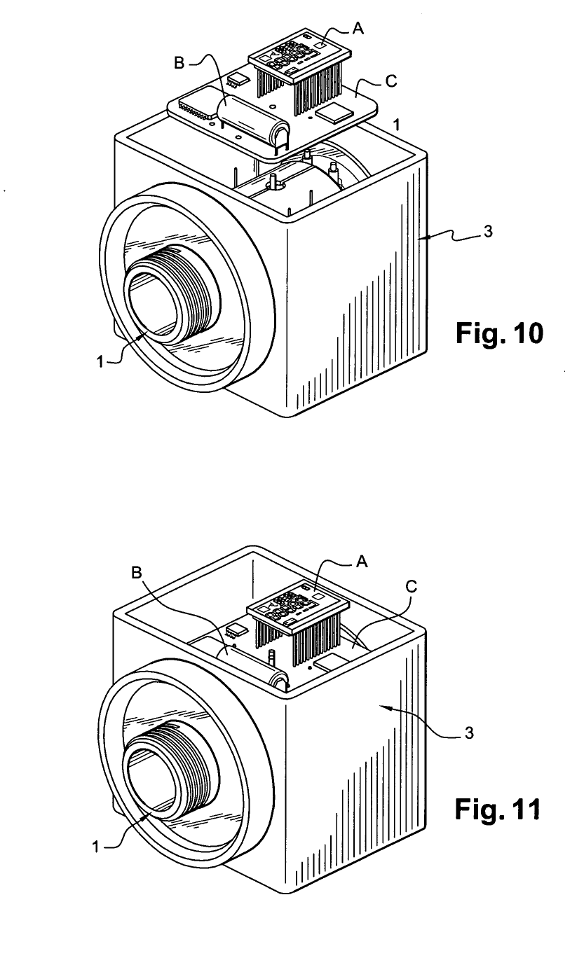

As shown in FIGS. 10 and 11, in a following assembly step, the data-processing parts comprise a printed circuit board C and a battery B together with a display unit A, and they are mounted in the case 3, with the ends of the connection pins from the electrodes E1, E2 and of the coils B1, B2 being connected to components of the printed circuit board C.

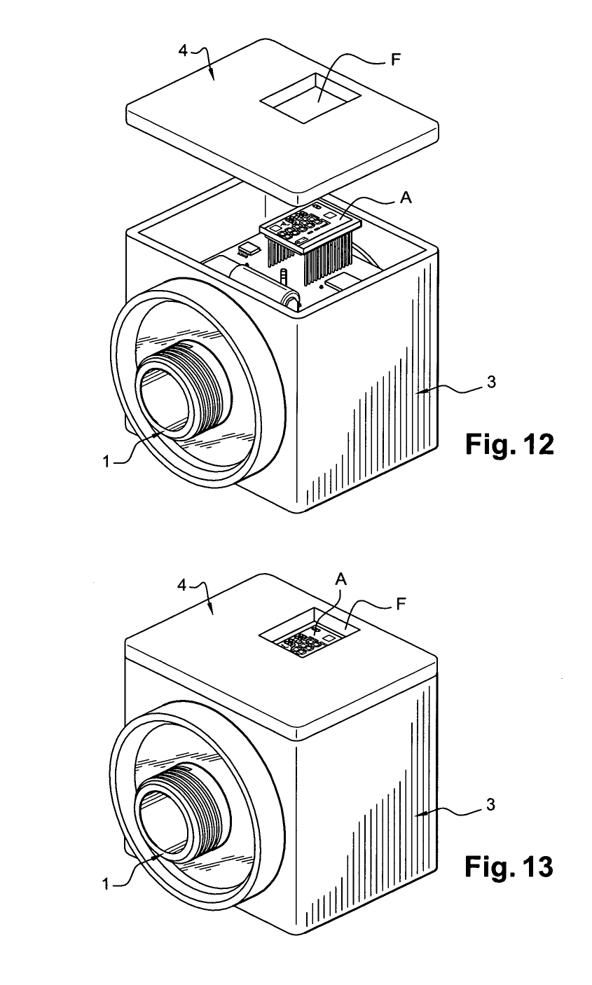

As shown in FIGS. 12 and 13, in a following assembly step, a cover 4 is mounted on the case 3 in order to close it, and it includes a window F for viewing the display unit A.

In this embodiment as described, the fluid meter is a meter with a magnetic flow sensor comprising two electrodes and two electromagnetic coils for creating an alternating magnetic field to which the two electrodes are subjected.

However the principle of the invention, which lies in separating the meter in two assembly modules, i.e. the measurement tube 1 and the case 3, can be applied to any type of meter having static measuring elements.

What is claimed is:

1. A static fluid meter including a flow rate sensor comprising:
a set of stationary measuring parts;
a measurement tube having one opening that serves as a fluid inlet and another opening as a fluid outlet, the tube containing internally a first set of said measuring parts and supporting externally a second set of said measuring parts; and
an outer case into which said measurement tube is inserted and fastened in leaktight manner, the outer case containing at least parts for processing data from said sensor,
wherein said case is made from a box provided with two through orifices in its sides for passing the measurement tube assembly and for leaktight fastening to corresponding flanges arranged on said measurement tube.

2. A meter according to claim 1, wherein said outer case contains a display unit.

3. A meter according to claim 1, wherein said measurement tube includes, on its wall, at least one stud, having engaged and fastened thereon a part of said second set.

4. A meter according to claim 1, wherein said measurement tube includes in its wall at least one orifice having a said part of the first set engaged and fastened therein.

5. A meter according to claim 1, wherein a shielding cap is placed around said second set of parts.

6. A meter according to claim 5, wherein said case is provided with a cover.

7. A static fluid meter including a magnetic flow sensor according to claim 1, wherein said first set of said measuring parts is made up of two electrodes.

8. A meter according to claim 7, wherein said second set of said measuring parts is made up of two electromagnetic coils.

9. A meter according to claim 1, wherein said parts for processor data comprise a printed circuit board and a battery.

10. A meter according to claim 1, wherein said measurement tube and said case are made of plastics material.
